(19) United States
(12) Patent Application Publication
(10) Pub. No.: US 2019/0190079 A1
(43) Pub. Date: Jun. 20, 2019

(54) NONAQUEOUS ELECTROLYTE SECONDARY BATTERY

(71) Applicant: Sumitomo Chemical Company, Limited, Tokyo (JP)

(72) Inventors: Ichiro ARISE, Osaka (JP); Toshihiko OGATA, Osaka (JP); Kosuke KURAKANE, Osaka (JP); Junji SUZUKI, Osaka (JP)

(21) Appl. No.: 16/224,797

(22) Filed: Dec. 19, 2018

(30) Foreign Application Priority Data
Dec. 19, 2017 (JP) 2017-243287

(51) Int. Cl. H01M 10/0585; H01M 10/0525; H01M 2/16; H01M 4/131; H01M 4/133; H01M 4/48; H01M 4/583

(52) U.S. Cl. CPC H01M 10/0585; H01M 10/0525; H01M 2/16; H01M 4/583; H01M 4/133; H01M 4/48; H01M 4/131

(57) ABSTRACT

A nonaqueous electrolyte secondary battery includes a separator including a polyolefin porous film; a porous layer containing a polyvinylidene fluoride-based resin; and a positive electrode plate and a negative electrode plate for which the sum of the interface barrier energies is not less than a predetermined value, the polyvinylidene fluoride-based resin containing an α-form polyvinylidene fluoride-based resin in an amount of not less than 35.0 mol %.

This Nonprovisional application claims priority under 35 U.S.C. § 119 on Patent Application No. 2017-243287 filed in Japan on Dec. 19, 2017, the entire contents of which are hereby incorporated by reference.

### TECHNICAL FIELD

The present invention relates to a nonaqueous electrolyte secondary battery.

### BACKGROUND ART

Nonaqueous electrolyte secondary batteries, particularly lithium secondary batteries, have a high energy density and are thus in wide use as batteries for, for example, personal computers, mobile telephones, and portable information terminals. Such nonaqueous electrolyte secondary batteries have recently been developed as on-vehicle batteries.

Patent Literature 1, for example, discloses a nonaqueous electrolyte secondary battery including a polyolefin porous film and a porous layer containing a polyvinylidene fluoride-based resin.

### CITATION LIST

### Patent Literature

[Patent Literature 1]

Japanese Patent No. 5432417 (Registration date: Dec. 13, 2013)

### SUMMARY OF INVENTION

### Technical Problem

The above conventional nonaqueous electrolyte secondary battery unfortunately has room for improvement in terms of the charge-discharge efficiency property after charge-discharge cycles.

It is an object of an aspect of the present invention to provide a nonaqueous electrolyte secondary battery that maintains its charge-discharge efficiency property after charge-discharge cycles.

### Solution to Problem

A nonaqueous electrolyte secondary battery in accordance with a first aspect of the present invention includes: a nonaqueous electrolyte secondary battery separator including a polyolefin porous film; a porous layer containing a polyvinylidene fluoride-based resin; a positive electrode plate; and a negative electrode plate, in a case where the positive electrode plate and the negative electrode plate have each been processed into a disk having a diameter of 15.5 mm and immersed in a solution of ethylene carbonate, ethyl methyl carbonate, and diethyl carbonate which solution contains LiPF₆ at a concentration of 1 M, a sum of respective interface barrier energies measured of a positive electrode active material and a negative electrode active material being not less than 5000 J/mol, the porous layer being between (i) the nonaqueous electrolyte secondary battery separator and (ii) at least one of the positive electrode plate and the negative electrode plate, the polyvinylidene fluoride-based resin containing an α-form polyvinylidene fluoride-based resin in an amount of not less than 35.0 mol % with respect to 100 mol % of a combined amount of the α-form polyvinylidene fluoride-based resin and a β-form polyvinylidene fluoride-based resin both contained in the polyvinylidene fluoride-based resin, the amount of the α-form polyvinylidene fluoride-based resin being calculated by (i) waveform separation of (α/2) observed at around −78 ppm in a ¹⁹F-NMR spectrum obtained from the porous layer and (ii) waveform separation of {(α/2)+β} observed at around −95 ppm in the ¹⁹F-NMR spectrum.

A nonaqueous electrolyte secondary battery in accordance with a second aspect of the present invention is configured as in the first aspect and is further configured such that the positive electrode plate contains a transition metal oxide.

A nonaqueous electrolyte secondary battery in accordance with a third aspect of the present invention is configured as in the first or second aspect and is further configured such that the negative electrode plate contains a graphite.

The nonaqueous electrolyte secondary battery in accordance with a fourth aspect of the present invention is configured as in any one of the first to third aspects and further includes: another porous layer which is provided between (i) the nonaqueous electrolyte secondary battery separator and (ii) at least one of the positive electrode plate and the negative electrode plate.

A nonaqueous electrolyte secondary battery in accordance with a fifth aspect of the present invention is configured as in the fourth aspect and is further configured such that the another porous layer contains at least one resin selected from the group consisting of a polyolefin, a (meth)acrylate-based resin, a fluorine-containing resin (excluding a polyvinylidene fluoride-based resin), a polyamide-based resin, a polyester-based resin, and a water-soluble polymer.

A nonaqueous electrolyte secondary battery in accordance with a sixth aspect of the present invention is configured as in the fifth aspect and is further configured such that the polyamide-based resin is aramid resin.

### Advantageous Effects of Invention

An aspect of the present invention provides a nonaqueous electrolyte secondary battery that maintains its charge-discharge efficiency property after charge-discharge cycles.

### DESCRIPTION OF EMBODIMENTS

The following description will discuss an embodiment of the present invention in detail. Note that numerical expressions such as “A to B” herein mean “not less than A and not more than B”.

### Embodiment 1: Nonaqueous Electrolyte Secondary Battery

A nonaqueous electrolyte secondary battery in accordance with Embodiment 1 of the present invention includes: a nonaqueous electrolyte secondary battery separator including a polyolefin porous film; a porous layer containing a polyvinylidene fluoride-based resin; a positive electrode plate; and a negative electrode plate, the porous layer being between (i) the nonaqueous electrolyte secondary battery separator and (ii) at least one of the positive electrode plate and the negative electrode plate, the nonaqueous electrolyte secondary battery having features (i) and (ii) below.

(i) In a case where the positive electrode plate and the negative electrode plate have each been processed into a disk having a diameter of 15.5 mm and immersed in a solution of ethylene carbonate, ethyl methyl carbonate, and diethyl carbonate which solution contains LiPF₆ at a concentration of 1 M, a sum of respective interface barrier energies measured of a positive electrode active material and a negative electrode active material (hereinafter referred to also as “sum of the interface barrier energies) being not less than 5000 J/mol.

(ii) The polyvinylidene fluoride-based resin containing an α-form polyvinylidene fluoride-based resin in an amount of not less than 35.0 mol % with respect to 100 mol % of a combined amount of the α-form polyvinylidene fluoride-based resin and a β-form polyvinylidene fluoride-based resin both contained in the polyvinylidene fluoride-based resin,

the amount of the α-form polyvinylidene fluoride-based resin being calculated by (i) waveform separation of (α/2) observed at around −78 ppm in a ¹⁹F-NMR spectrum obtained from the porous layer and (ii) waveform separation of {(α/2)+β} observed at around −95 ppm in the ¹⁹F-NMR spectrum.

Note that a nonaqueous electrolyte secondary battery in accordance with an embodiment of the present invention includes not only the above-described positive electrode plate, negative electrode plate, nonaqueous electrolyte secondary battery separator, and porous layer but also other component(s) such as a nonaqueous electrolyte.

<Nonaqueous Electrolyte Secondary Battery Separator>

A nonaqueous electrolyte secondary battery separator in accordance with an embodiment of the present invention includes a polyolefin porous film (hereinafter also referred to as “porous film”).

The porous film itself can be the nonaqueous electrolyte secondary battery separator. The porous film itself can also be a base material of a nonaqueous electrolyte secondary battery laminated separator in which a porous layer (described later) is disposed on the porous film. The porous film contains polyolefin as a main component and has a large number of pores therein, which pores are connected to one another, so that a gas and a liquid can pass through the porous film from one surface of the porous film to the other.

The nonaqueous electrolyte secondary battery separator in accordance with an embodiment of the present invention may be provided with, disposed on at least one surface thereof, a porous layer (described later) containing a polyvinylidene fluoride-based resin. This laminated body, in which the porous layer is disposed on at least one surface of the nonaqueous electrolyte secondary battery separator, is referred to in the present specification as a “nonaqueous electrolyte secondary battery laminated separator” or a “laminated separator”. Further, the nonaqueous electrolyte secondary battery separator in accordance with an embodiment of the present invention may include, in addition to a polyolefin porous film, another layer(s) such as an adhesive layer, a heat-resistant layer, and/or a protective layer.

The porous film contains a polyolefin at a proportion of not less than 50% by volume, preferably not less than 90% by volume, more preferably not less than 95% by volume, relative to the entire porous film. The polyolefin preferably contains a high molecular weight component having a weight-average molecular weight within a range of 5×10⁵ to 15×10⁶. In particular, the polyolefin more preferably contains a high molecular weight component having a weight-average molecular weight of not less than 1,000,000 because such a polyolefin allows the nonaqueous electrolyte secondary battery separator to have a higher strength.

Specific examples of the polyolefin (thermoplastic resin) include a homopolymer or a copolymer each produced by (co)polymerizing a monomer such as ethylene, propylene, 1-butene, 4-methyl-1-pentene, or 1-hexene. Examples of the homopolymer include polyethylene, polypropylene, and polybutene. Examples of the copolymer include an ethylene-propylene copolymer.

Among the above examples, polyethylene is preferable as it is capable of preventing (shutting down) a flow of an excessively large electric current at a lower temperature. Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is further preferable.

The porous film has a film thickness of preferably 4 μm to 40 μm, more preferably 5 μm to 30 μm, still more preferably 6 μm to 15 μm.

The porous film only needs to have a weight per unit area which weight is determined as appropriate in view of the strength, film thickness, weight, and handleability of the separator. Note, however, that the porous film has a weight per unit area of preferably 4 g/m² to 20 g/m², more preferably 4 g/m² to 12 g/m², still more preferably 5 g/m² to 10 g/m², so as to allow a nonaqueous electrolyte secondary battery that includes a nonaqueous electrolyte secondary battery separator including the porous film to have a higher weight energy density and a higher volume energy density.

The porous film has an air permeability of preferably 30 sec/100 mL to 500 sec/100 mL, more preferably 50 sec/100 mL to 300 sec/100 mL, in terms of Gurley values. A porous film having an air permeability within the above range can have sufficient ion permeability.

The porous film has a porosity of preferably 20% by volume to 80% by volume, more preferably 30% by volume to 75% by volume, so as to (i) retain a larger amount of electrolyte and (ii) obtain the function of reliably preventing (shutting down) a flow of an excessively large electric current at a lower temperature. Further, in order to obtain sufficient ion permeability and prevent particles from entering the positive electrode and/or the negative electrode, the porous film has pores each having a pore size of preferably not larger than 0.3 μm, more preferably not larger than 0.14 μm.

The porous film has a white index (WI) (hereinafter also referred to simply as “white index (WI)” or “WI”) of preferably not less than 85 and not more than 98, more preferably not less than 90, even more preferably not more than 97, the white index (WI) being defined in American Standard Test Methods (hereinafter abbreviated as “ASTM”) E313.

WI is an indicator of a color tone (whiteness) of a sample, and is used to indicate, for example, (i) the fading characteristic of a dye or (ii) the degree of oxidation degradation in transparent or white resin being processed. A higher WI value means a higher degree of whiteness. A lower WI value means a lower degree of whiteness. Further, a lower WI value should indicate a larger amount of functional groups such as a carboxy group at the surface of the porous film which surface is in contact with air (oxygen) (for example, the surface of pores in the porous film). Such functional groups prevent permeation of Li ions and consequently lower the ion permeability. A porous film having a high WI value should mean that reflection and scattering caused therein have low wavelength dependency.

A porous film can be produced by, for example, (i) a method of adding a filler (pore forming agent) to a resin such as polyolefin, shaping the resin into a sheet, then removing the filler with use of an appropriate solvent, and stretching the sheet from which the filler has been removed, or (ii) a method of adding a filler to a resin such as polyolefin, shaping the resin into a sheet, then stretching the sheet, and removing the filler from the stretched sheet. This means that a porous film as a final product normally does not contain a filler.

The inventor of the present invention has discovered that a porous film can have a WI value of not less than 85 and not more than 98 in a case where (i) generation of a functional group such as a carboxyl group is prevented by using, during production of the porous film, a filler having a large BET specific surface area to allow for an increase in dispersibility of the filler and to consequently prevent local oxidation degradation resulting from defective dispersion of the filler during heat processing, and (ii) the porous film is made denser.

The “filler having a large BET specific surface area” refers to a filler having a BET specific surface area of not less than 6 m²/g and not more than 16 m²/g. A filler having a BET specific surface area of less than 6 m²/g is not preferable. This is because such a filler tends to cause large-sized pores to be developed. A filler having a BET specific surface area of more than 16 m²/g will cause agglomeration of the filler and will consequently cause defective dispersion of the filler, so that dense pores are less likely to be developed. The filler has a BET specific surface area of preferably not less than 8 m²/g and not more than 15 m²/g, more preferably not less than 10 m²/g and not more than 13 m²/g.

Specific examples of the filler include fillers made of inorganic matters such as calcium carbonate, magnesium carbonate, barium carbonate, calcium sulfate, magnesium sulfate, and barium sulfate. The porous film can contain (i) only one kind of filler or (ii) two or more kinds of fillers in combination. Among the above examples, a filler made of calcium carbonate is particularly preferable from the viewpoint of its large BET specific surface area.

Whether a porous film has a WI value of not less than 85 and not more than 98 can be determined through, for example, measurements of the WI value with use of an integrating-sphere spectrocolorimeter. The above porous film has a front surface and a back surface both of which satisfy the requirement of a WI value of not less than 85 and not more than 98.

In a case where a porous film has a WI value of not less than 85 and not more than 98, the amount of functional groups such as a carboxy group at the surface of the porous film which surface is in contact with air (oxygen) is appropriate, making it possible to increase the ion permeability within an appropriate range.

If a porous film has a WI value of less than 85, the amount of the above functional groups will be large, reducing the ion permeability of the porous film.

If a porous film has a WI value of more than 98, the amount of functional groups at the surface of the porous film which surface is in contact with air (oxygen) will be too small, undesirably decreasing the compatibility of the film with electrolyte.

In a case where a porous film is provided with a porous layer or another layer each disposed on the porous film, the physical property values of the porous film, which is included in a laminated body including the porous film and a porous layer or another layer, can be measured after the porous layer or other layer is removed from the laminated body. The porous layer or other layer can be removed from the laminated body by, for example, a method of dissolving the resin of the porous layer or other layer with use of a solvent such as N-methylpyrrolidone or acetone for removal.

<Porous Layer>

For an embodiment of the present invention, the porous layer is disposed, as a member of a nonaqueous electrolyte secondary battery, between (i) the nonaqueous electrolyte secondary battery separator and (ii) at least one of the positive electrode plate and the negative electrode plate. The porous layer may be present on one surface or both surfaces of the nonaqueous electrolyte secondary battery separator. The porous layer may alternatively be disposed on an active material layer of at least one of the positive electrode plate and the negative electrode plate. The porous layer may alternatively be provided between the nonaqueous electrolyte secondary battery separator and at least one of the positive electrode plate and the negative electrode plate in such a manner as to be in contact with the nonaqueous electrolyte secondary battery separator and the at least one of the positive electrode plate and the negative electrode plate. There may be a single porous layer or two or more porous layers between the nonaqueous electrolyte secondary battery separator and at least one of the positive electrode plate and the negative electrode plate.

The porous layer is preferably an insulating porous layer containing a resin.

It is preferable that a resin that may be contained in the porous layer be insoluble in the electrolyte of the battery and be electrochemically stable when the battery is in normal use. In a case where the porous layer is disposed on one surface of the porous film, the porous layer is preferably disposed on that surface of the porous film which surface faces the positive electrode plate of the nonaqueous electrolyte secondary battery, more preferably on that surface of the porous film which surface comes into contact with the positive electrode plate.

The porous layer in an embodiment of the present invention contains a PVDF-based resin, the PVDF-based resin containing an α-form PVDF-based resin in an amount of not less than 35.0 mol % with respect to 100 mol % of the combined amount of the α-form PVDF-based resin and a β-form PVDF-based resin both contained in the PVDF-based resin.

The content of an α-form PVDF-based resin is calculated by (i) waveform separation of (α/2) observed at around −78 ppm in a ¹⁹F-NMR spectrum obtained from the porous layer and (ii) waveform separation of {(α/2)+β} observed at around −95 ppm in the ¹⁹F-NMR spectrum obtained from the porous layer.

The porous layer contains a large number of pores connected to one another, and thus allows a gas or a liquid to pass therethrough from one surface to the other. Further, in a case where the porous layer in accordance with an embodiment of the present invention is used as a constituent member of a nonaqueous electrolyte secondary battery laminated separator, the porous layer can be a layer capable of adhering to an electrode as the outermost layer of the separator.

Examples of the PVDF-based resin include homopolymers of vinylidene fluoride, copolymers of vinylidene fluoride and other monomer(s) copolymerizable with vinylidene fluoride, and mixtures of the above polymers. Examples of the monomer copolymerizable with vinylidene fluoride include hexafluoropropylene, tetrafluoroethylene, trifluoroethylene, trichloroethylene, and vinyl fluoride. The present embodiment can use (i) one kind of monomer or (ii) two or more kinds of monomers selected from the above. The PVDF-based resin can be synthesized through emulsion polymerization or suspension polymerization.

The PVDF-based resin contains vinylidene fluoride at a proportion of normally not less than 85 mol %, preferably not less than 90 mol %, more preferably not less than 95 mol %, further preferably not less than 98 mol %. A PVDF-based resin containing vinylidene fluoride at a proportion of not less than 85 mol % is more likely to allow a porous layer to have a mechanical strength against pressure and a heat resistance against heat during battery production.

The porous layer can also preferably contain two kinds of PVDF-based resins (that is, a first resin and a second resin below) that differ from each other in terms of, for example, the hexafluoropropylene content.

The first resin is (i) a vinylidene fluoride-hexafluoropropylene copolymer containing hexafluoropropylene at a proportion of more than 0 mol % and not more than 1.5 mol % or (ii) a vinylidene fluoride homopolymer.

The second resin is a vinylidene fluoride-hexafluoropropylene copolymer containing hexafluoropropylene at a proportion of more than 1.5 mol %.

A porous layer containing the two kinds of PVDF-based resins adheres better to an electrode than a porous layer not containing one of the two kinds of PVDF-based resins. Further, a porous layer containing the two kinds of PVDF-based resins adheres better to another layer (for example, the porous film layer) included in a nonaqueous electrolyte secondary battery separator than a porous layer not containing one of the two kinds of PVDF-based resins, with the result of a higher peel strength between the two layers. The first resin and the second resin preferably have a mass ratio of 15:85 to 85:15.

The PVDF-based resin has a weight-average molecular weight of preferably 200,000 to 3,000,000, more preferably 200,000 to 2,000,000, even more preferably 500,000 to 1,500,000. A PVDF-based resin having a weight-average molecular weight of not less than 200,000 tends to allow a porous layer and an electrode to adhere to each other sufficiently. A PVDF-based resin having a weight-average molecular weight of not more than 3,000,000 tends to allow for excellent shaping easiness.

The porous layer in accordance with an embodiment of the present invention may contain a resin other than the PVDF-based resin. Examples of the other resin include a styrene-butadiene copolymer; homopolymers or copolymers of vinyl nitriles such as acrylonitrile and methacrylonitrile; and polyethers such as polyethylene oxide and polypropylene oxide.

The porous layer in accordance with an embodiment of the present invention may contain a filler such as an inorganic filler and an organic filler (for example, fine metal oxide particles). The filler is contained at a proportion of preferably not less than 1% by mass and not more than 99% by mass, more preferably not less than 10% by mass and not more than 98% by mass, relative to the combined amount of the PVDF-based resin and the filler. The proportion of the filler may have a lower limit of not less than 50% by mass, not less than 70% by mass, or not less than 90% by mass. The organic or inorganic filler may be a conventionally publicly known filler.

The porous layer in accordance with an embodiment of the present invention has an average thickness of preferably 0.5 μm to 10 μm, more preferably 1 μm to 5 μm, per layer in order to ensure adhesion to an electrode and a high energy density.

A porous layer having a film thickness of not less than 0.5 μm per layer can (i) sufficiently reduce the possibility of internal short circuiting resulting from, for example, a breakage of the nonaqueous electrolyte secondary battery and (ii) retain a sufficient amount of electrolyte.

If the porous layer has a thickness of more than 10 μm per layer, the nonaqueous electrolyte secondary battery will have an increased resistance to permeation of lithium ions. Thus, repeating charge-and-discharge cycles will degrade the positive electrode of the nonaqueous electrolyte secondary battery, with the result of a degraded rate characteristic and a degraded cycle characteristic. Further, such a porous layer will increase the distance between the positive electrode and the negative electrode, with the result of a decrease in the internal capacity efficiency of the nonaqueous electrolyte secondary battery.

The porous layer in accordance with the present embodiment is preferably disposed between the nonaqueous electrolyte secondary battery separator and the positive electrode active material layer of the positive electrode plate. The descriptions below of the physical properties of the porous layer are at least descriptions of the physical properties of a porous layer disposed between the nonaqueous electrolyte secondary battery separator and the positive electrode active material layer of the positive electrode plate in a nonaqueous electrolyte secondary battery.

The porous layer only needs to have a weight per unit area (per layer) which weight is appropriately determined in view of the strength, film thickness, weight, and handleability of the porous layer. The material(s) of the porous layer is applied in an amount (weight per unit area) of preferably 0.5 g/m² to 20 g/m², more preferably 0.5 g/m² to 10 g/m², per layer.

A porous layer having a weight per unit area which weight falls within the above numerical range allows a nonaqueous electrolyte secondary battery including the porous layer to have a higher weight energy density and a higher volume energy density. If the weight per unit area of the porous layer is beyond the above range, the nonaqueous electrolyte secondary battery will be heavy.

The porous layer has a porosity of preferably 20% by volume to 90% by volume, more preferably 30% by volume to 80% by volume, in order to achieve sufficient ion permeability. The pore diameter of the pores in the porous layer is preferably not more than 1.0 μm, more preferably not more than 0.5 μm. In a case where the pores each have such a pore diameter, the porous layer can achieve sufficient ion permeability.

The porous layer in accordance with an embodiment of the present invention has a surface roughness, in terms of a ten-point average roughness (Rz), of preferably 0.8 μm to 8.0 μm, more preferably 0.9 μm to 6.0 μm, even more preferably 1.0 μm to 3.0 μm. The ten-point average roughness (Rz) is a value measured by a method in conformity with JISB 0601-1994 (or Rzjis of JIS B 0601-2001). Specifically, Rz is a value measured with use of ET4000 (available from Kosaka Laboratory Ltd.) with a measurement length of 1.25 mm, a measurement rate of 0.1 mm/sec, and a temperature and humidity of 25° C./50% RH.

The porous layer in accordance with an embodiment of the present invention has a coefficient of kinetic friction of preferably 0.1 to 0.6, more preferably 0.1 to 0.4, even more preferably 0.1 to 0.3. The coefficient of kinetic friction is a value measured by a method in conformity with JIS K 7125. Specifically, the coefficient of kinetic friction for the present invention is a value measured with use of Surface Property Tester (available from Heidon).

The nonaqueous electrolyte secondary battery laminated separator in accordance with an embodiment of the present invention, as mentioned above, includes a porous film having a predetermined WI value and excellent ion permeability.

The nonaqueous electrolyte secondary battery laminated separator has an air permeability of preferably 30 sec/100 mL to 1000 sec/100 mL, more preferably 50 sec/100 mL to 800 sec/100 mL, in terms of Gurley values. The nonaqueous electrolyte secondary battery laminated separator, which has the above air permeability, allows the nonaqueous electrolyte secondary battery to have sufficient ion permeability.

An air permeability less than the above range means that the nonaqueous electrolyte secondary battery laminated separator has a high porosity and thus has a coarse laminated structure. This may result in a nonaqueous electrolyte secondary battery laminated separator having a lower strength and thus having an insufficient shape stability at high temperatures in particular. An air permeability larger than the above range may, on the other hand, prevent the nonaqueous electrolyte secondary battery laminated separator from having sufficient ion permeability and thus degrade the battery characteristics of the nonaqueous electrolyte secondary battery.

(Crystal Forms of PVDF-Based Resin)

The PVDF-based resin included in the porous layer in accordance with an embodiment of the present invention is such that, assuming that the sum of the amounts of an α-form PVDF-based resin and a β-form PVDF-based resin both contained in the PVDF-based resin is 100 mol %, the amount of an α-form PVDF-based resin contained in the PVDF-based resin is not less than not less than 35.0 mol %, preferably not less than 37.0 mol %, more preferably not less than 40.0 mol %, even more preferably not less than 44.0 mol %. Further, the amount of the α-form PVDF-based resin is preferably not more than 90.0 mol %. The porous layer, which contains an α-form PVDF-based resin in an amount within the above range, is suitably usable as a member of a nonaqueous electrolyte secondary battery that maintains its good charge-discharge efficiency property after charge-discharge cycles, in particular as a member of a laminated separator of a nonaqueous electrolyte secondary battery or as a member of an electrode of a nonaqueous electrolyte secondary battery.

A nonaqueous electrolyte secondary battery has a high internal temperature after repeated charge and discharge as a result of heat generated during charge and discharge. The α-form PVDF-based resin of a PVDF-based resin has a melting point higher than the β-form PVDF-based resin thereof, and is less susceptible to thermal plastic deformation. Further, since the β-form PVDF-based resin is structured such that fluorine atoms are arranged on one direction, the β-form PVDF-based resin is known to have a polarity higher than the α-form PVDF-based resin.

For an embodiment of the present invention, the porous layer contains a PVDF-based resin containing an α-form PVDF-based resin at a proportion not less than a certain level as described above. This makes it possible to reduce, for example, deformation of the internal structure of the porous layer and blocking of pores both resulting from the PVDF-based resin being deformed due to high temperatures caused by repeated charge-and-discharge cycles. This in turn prevents the ion permeability of the porous layer from being decreased as a result of repeated charge and discharge cycles, and allows the nonaqueous electrolyte secondary battery to maintain its good charge-discharge efficiency property after charge-discharge cycles.

The PVDF-based resin containing an α-form PVDF-based resin is arranged such that the polymer of the PVDF-based resin contains a PVDF skeleton having molecular chains including a main-chain carbon atom bonded to a fluorine atom (or a hydrogen atom) adjacent to two carbon atoms one of which is bonded to a hydrogen atom (or a fluorine atom) having a trans position and the other (opposite) one of which is bonded to a hydrogen atom (or a fluorine atom) having a gauche position (positioned at an angle of 60°), wherein two or more such conformations are chained consecutively as follows:

(TGTG̅ structure) [Math. 1]

and the molecular chains each have the following type:

TGTG̅ [Math. 2]

wherein the respective dipole moments of C—F₂ and C—H₂ bonds each have a component perpendicular to the molecular chain and a component parallel to the molecular chain.

A PVDF-based resin containing an α-form PVDF-based resin has characteristic peaks at around −95 ppm and at around −78 ppm in a ¹⁹F-NMR spectrum.

The PVDF-based resin containing a β-form PVDF-based resin is arranged such that the polymer of the PVDF-based resin contains a PVDF skeleton having molecular chains including a main-chain carbon atom adjacent to two carbon atoms bonded to a fluorine atom and a hydrogen atom, respectively, each having a trans conformation (TT-type conformation), that is, the fluorine atom and the hydrogen atom bonded respectively to the two carbon atoms are positioned oppositely at an angle of 180° to the direction of the carbon-carbon bond.

The PVDF-based resin containing a β-form PVDF-based resin may be arranged such that the polymer of the PVDF-based resin contains a PVDF skeleton that has a TT-type conformation in its entirety. The PVDF-based resin containing a β-form PVDF-based resin may alternatively be arranged such that a portion of the PVDF skeleton has a TT-type conformation and that the PVDF-based resin containing a β-form PVDF-based resin has a molecular chain of the TT-type conformation in at least four consecutive PVDF monomeric units. In either case, (i) the carbon-carbon bond, in which the TT-type conformation constitutes a TT-type main chain, has a planar zigzag structure, and (ii) the respective dipole moments of C—F₂ and C—H₂ bonds each have a component perpendicular to the molecular chain.

A PVDF-based resin containing a β-form PVDF-based resin has characteristic peaks at around −95 ppm in a ¹⁹F-NMR spectrum.

(Method for Calculating Content Rates of α-Form PVDF-Based Resin and β-Form PVDF-Based Resin in PVDF-Based Resin)

The rate of content of an α-form PVDF-based resin and the rate of content of a β-form PVDF-based resin in the porous layer in accordance with an embodiment of the present invention relative to 100 mol % of the combined content of the α-form PVDF-based resin and the β-form PVDF-based resin may be calculated from a ¹⁹F-NMR spectrum obtained from the porous layer. The content rates are specifically calculated as follows, for example:

(1) An ¹⁹F-NMR spectrum is obtained from a porous layer containing a PVDF-based resin, under the following conditions.

Measurement Conditions

Measurement device: AVANCE400 available from Bruker Biospin

Measurement method: single-pulse method

Observed nucleus: ¹⁹F

Spectral bandwidth: 100 kHz

Pulse width: 3.0 s (90° pulse)

Pulse repetition time: 5.0 s

Reference material: C₆F₆ (external reference: −163.0 ppm)

Temperature: 22° C.

Sample rotation frequency: 25 kHz

(2) An integral value of a peak at around −78 ppm in the ¹⁹F-NMR spectrum obtained in (1) is calculated and is regarded as an α/2 amount.

(3) As with the case of (2), an integral value of a peak at around −95 ppm in the ¹⁹F-NMR spectrum obtained in (1) is calculated and is regarded as an {(α/2)+β} amount.

(4) Assuming that the sum of (i) the content of an α-form PVDF-based resin and (ii) the content of a β-form PVDF-based resin is 100 mol %, the rate of content of the α-form PVDF-based resin (hereinafter referred to also as “a rate”) is calculated from the integral values of (2) and (3) in accordance with the following Expression (1):

α rate (mol %)=[(integral value at around −78 ppm)×2/{(integral value at around −95 ppm)+(integral value at around −78 ppm)}]×100 (1)

(5) Assuming that the sum of (i) the content of an α-form PVDF-based resin and (ii) the content of a β-form PVDF-based resin is 100 mol %, the rate of content of the β-form PVDF-based resin (hereinafter referred to also as “β rate”) is calculated from the value of the a rate of (4) in accordance with the following Expression (2):

β rate (mol %)=100 (mol %)−a rate (mol %) (2)

(Method for Producing Porous Layer and Nonaqueous Electrolyte Secondary Battery Laminated Separator)

A porous layer and nonaqueous electrolyte secondary battery laminated separator each in accordance with an embodiment of the present invention may each be produced by any of various production methods.

In an example method, a porous layer containing a PVDF-based resin and optionally a filler is formed through one of the processes (1) to (3) below on a surface of a porous film intended to be a base material. In the case of the process (2) or (3), a porous layer deposited is dried for removal of the solvent. In the processes (1) to (3), the coating solution, in the case of production of a porous layer containing a filler, preferably contains a filler dispersed therein and a PVDF-based resin dissolved therein.

The coating solution for use in a method for producing a porous layer in accordance with an embodiment of the present invention can be prepared typically by (i) dissolving, in a solvent, a resin to be contained in the porous layer and (ii) in a case where a filler is to be contained in the porous layer, dispersing the filler in the solvent.

(1) A process of (i) coating a surface of a porous film with a coating solution containing fine particles of a PVDF-based resin to be contained in a porous layer and optionally fine particles of a filler and (ii) drying the surface of the porous film to remove the solvent (dispersion medium) from the coating solution for formation of a porous layer.

(2) A process of (i) coating a surface of a porous film with the coating solution described in (1) and then (ii) immersing the porous film into a deposition solvent (which is a poor solvent for the PVDF-based resin) for deposition of a porous layer.

(3) A process of (i) coating a surface of a porous film with the coating solution described in (1) and then (ii) making the coating solution acidic with use of a low-boiling-point organic acid for deposition of a porous layer.

Examples of the solvent (dispersion medium) in the coating solution include N-methylpyrrolidone, N,N-dimethylacetamide, N,N-dimethylformamide, acetone, and water.

The deposition solvent is preferably isopropyl alcohol or t-butyl alcohol, for example.

For the process (3), the low-boiling-point organic acid can be, for example, paratoluene sulfonic acid or acetic acid.

The coating solution may contain an additive(s) as appropriate such as a dispersing agent, a plasticizing agent, a surface active agent, and a pH adjusting agent as a component(s) other than the resin and the filler.

The base material can be, other than a porous film, another film, a positive electrode plate, a negative electrode plate, or the like.

The coating solution can be applied to the base material by a conventionally publicly known method. Specific examples of such a method include a gravure coater method, a dip coater method, a bar coater method, and a die coater method.

(Method for Controlling Crystal Forms of PVDF-Based Resin)

The crystal form of the PVDF-based resin contained in the porous layer in accordance with an embodiment of the present invention can be controlled on the basis of (i) drying conditions such as the drying temperature, and the air velocity and air direction during drying and (ii) the deposition temperature at which a porous layer containing a PVDF-based resin is deposited with use of a deposition solvent or a low-boiling-point organic acid.

In a case where the coating solution is simply dried as in the process (1), the drying conditions may be changed as appropriate by adjusting, for example, the amount of the solvent in the coating solution, the concentration of the PVDF-based resin in the coating solution, the amount of the filler (if contained), and/or the amount of the coating solution to be applied. In a case where a porous layer is to be formed through the above process (1), it is preferable that the drying temperature be 30° C. to 100° C., that the direction of hot air for drying be perpendicular to a nonaqueous electrolyte secondary battery separator or electrode plate to which the coating solution has been applied, and that the velocity of the hot air be 0.1 m/s to 40 m/s. Specifically, in a case where a coating solution to be applied contains N-methyl-2-pyrrolidone as the solvent for dissolving a PVDF-based resin, 1.0% by mass of a PVDF-based resin, and 9.0% by mass of alumina as an inorganic filler, the drying conditions are preferably adjusted so that the drying temperature is 40° C. to 100° C., that the direction of hot air for drying is perpendicular to a nonaqueous electrolyte secondary battery separator or electrode plate to which the coating solution has been applied, and that the velocity of the hot air is 0.4 m/s to 40 m/s.

In a case where a porous layer is to be formed through the above process (2), it is preferable that the deposition temperature be −25° C. to 60° C. and that the drying temperature be 20° C. to 100° C. Specifically, in a case where a porous layer is to be formed through the above process (2) with use of N-methylpyrrolidone as the solvent for dissolving a PVDF-based resin and isopropyl alcohol as the deposition solvent, it is preferable that the deposition temperature be −10° C. to 40° C. and that the drying temperature be 30° C. to 80° C.

(Another Porous Layer)

The nonaqueous electrolyte secondary battery in accordance with an embodiment of the present invention can contain another porous layer in addition to (i) the porous film and (ii) the porous layer containing the PVDF-based resin. The another porous layer need only be provided between (i) the nonaqueous electrolyte secondary battery separator and (ii) at least one of the positive electrode plate and the negative electrode plate. The porous layer and the another porous layer may be provided in any order with respect to the nonaqueous electrolyte secondary battery separator. In a preferable configuration, the porous film, the another porous layer, and the porous layer containing the PVDF-based resin are disposed in this order. In other words, the another porous layer is provided between the porous film and the porous layer containing the PVDF-based resin. In another preferable configuration, the another porous layer and the porous layer containing the PVDF-based resin are provided in this order on both surfaces of the porous film.

Examples of a resin which can be contained in the another porous layer in accordance with an embodiment of the present invention encompass: polyolefins; (meth)acrylate-based resins; fluorine-containing resins (excluding polyvinylidene fluoride-based resins); polyamide-based resins; polyimide-based resins; polyester-based resins; rubbers; resins with a melting point or glass transition temperature of not lower than 180° C.; water-soluble polymers; polycarbonate, polyacetal, and polyether ether ketone.

Among the above resins, polyolefins, (meth)acrylate-based resins, polyamide-based resins, polyester-based resins, and water-soluble polymers are preferable.

Preferable examples of the polyolefin encompass polyethylene, polypropylene, polybutene, and an ethylene-propylene copolymer.

Examples of the fluorine-containing resins include polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Particular examples of the fluorine-containing resins include fluorine-containing rubber having a glass transition temperature of not higher than 23° C.

Preferable examples of the polyamide-based resin encompass aramid resins such as aromatic polyamide and wholly aromatic polyamide.

Specific examples of the aramid resin encompass poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2,6-naphthalene dicarboxylic acid amide), poly(2-chloroparaphenylene terephthalamide), a paraphenylene terephthalamide/2,6-dichloroparaphenylene terephthalamide copolymer, and a metaphenylene terephthalamide/2,6-dichloroparaphenylene terephthalamide copolymer. Among these aramid resins, poly(paraphenylene terephthalamide) is more preferable.

Preferable examples of the polyester-based resin encompass (i) aromatic polyesters such as polyarylate and (ii) liquid crystal polyesters.

Examples of the rubbers encompass a styrene-butadiene copolymer and a hydride thereof, a methacrylic acid ester copolymer, an acrylonitrile-acrylic acid ester copolymer, a styrene-acrylic acid ester copolymer, an ethylene propylene rubber, and polyvinyl acetate.

Examples of the resin with a melting point or a glass transition temperature of not lower than 180° C. encompass polyphenylene ether, polysulfone, polyether sulfone, polyphenylene sulfide, polyetherimide, polyamide imide, and polyether amide.

Examples of the water-soluble polymer encompass polyvinyl alcohol, polyethylene glycol, cellulose ether, sodium alginate, polyacrylic acid, polyacrylamide, and polymethacrylic acid.

Only one kind of these resins to be contained in the another porous layer can be used, or two or more kinds of these resins can be used in combination.

The other characteristics (e.g., thickness) of the another porous layer are similar to those (of the porous layer) described above, except that the porous layer contains the PVDF-based resin.

<Positive Electrode Plate>

The positive electrode plate in accordance with an embodiment of the present invention is not limited to any particular one as long as the following requirement is met: In a case where the positive electrode plate and the negative electrode plate (described later) have each been processed into a disk having a diameter of 15.5 mm and immersed in a solution of ethylene carbonate, ethyl methyl carbonate, and diethyl carbonate which solution contains LiPF₆ at a concentration of 1 M, the sum of the interface barrier energies measured of the positive electrode active material and the negative electrode active material is not less than 5000 J/mol. The positive electrode plate is, for example, a sheet-shaped positive electrode plate including (i) as a positive electrode active material layer, a positive electrode mix containing a positive electrode active material, an electrically conductive agent, and a binding agent and (ii) a positive electrode current collector supporting the positive electrode mix thereon. Note that the positive electrode plate may be such that the positive electrode current collector supports the positive electrode mix on both surfaces thereof or one of the surfaces thereof.

The positive electrode active material is, for example, a material capable of being doped with and dedoped of lithium ions. Such a material is preferably a transition metal oxide. Specific examples of the transition metal oxide include a lithium complex oxide containing at least one transition metal such as V, Mn, Fe, Co, or Ni.

Examples of the electrically conductive agent include carbonaceous materials such as natural graphite, artificial graphite, cokes, carbon black, pyrolytic carbons, carbon fiber, and a fired product of an organic polymer compound. The positive electrode plate can contain (i) only one kind of electrically conductive agent or (ii) two or more kinds of electrically conductive agents in combination.

Examples of the binding agent includes thermoplastic resins such as polyvinylidene fluoride, a copolymer of vinylidene fluoride, polytetrafluoroethylene, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-hexafluoropropylene copolymer, a vinylidene fluoride-hexafluoropropylene-tetrafluoroethylene copolymer, a thermoplastic polyimide, polyethylene, and polypropylene, as well as acrylic resin and styrene-butadiene-rubber. The binding agent functions also as a thickening agent.

Examples of the positive electrode current collector include electric conductors such as Al, Ni, and stainless steel. Among these, Al is preferable as it is easy to process into a thin film and less expensive.

Examples of a method for producing a sheet-shaped positive electrode plate include: a method in which a positive electrode active material, an electrically conductive agent, and a binding agent are pressure-molded on a positive electrode current collector; and a method in which (i) a positive electrode active agent, an electrically conductive agent, and a binding agent are formed into a paste as a positive electrode mix with the use of a suitable organic solvent, (ii) a positive electrode current collector is coated with the paste, and then (iii) the paste is dried and then pressured so that the paste is firmly fixed to the positive electrode current collector.

The particle diameter of the positive electrode active material is expressed as, for example, an average particle diameter (D50) per volume. The positive electrode active material normally has an average particle diameter per volume of approximately 0.1 μm to 30 μm. The average particle diameter (D50) per volume of the positive electrode active material can be measured with use of a laser diffraction particle size analyzer (product name: SALD2200, available from Shimadzu Corporation).

The positive electrode active material normally has an aspect ratio (that is, the long-axis diameter/the short-axis diameter) of approximately 1 to 100. The aspect ratio of the positive electrode active material can be determined by the following method: In an SEM image formed by observing the positive electrode active material on a flat surface from above in a direction perpendicular to the surface, the average is calculated (as the aspect ratio) of the ratios of the respective long-axis dimensions (long-axis diameters) and short-axis dimensions (short-axis diameters) of 100 particles of the positive electrode active material which 100 particles do not coincide with one another in the thickness direction of the positive electrode active material.

The positive electrode active material layer normally has a porosity of approximately 10% to 80%. The porosity (c) of a positive electrode active material layer can be calculated, by the formula below, from a density p (g/m³) of a positive electrode active material layer, respective mass compositions (weight %) b¹, b², . . . bⁿ of materials that constitute the positive electrode active material layer (e.g., a positive electrode active material, an electrically conductive agent, a binding agent, and others), and respective real densities (g/m³) c¹, c², . . . cⁿ of these materials. Note here that the real densities of the materials may be literature data or may be measured values obtained by a pycnometer method.

ε=1−{ρ×(b¹/100)/c¹+ρ×(b²/100)/c²+ . . . ρ×(bⁿ/100)/cⁿ}×100

The positive electrode active material layer normally contains a positive electrode active material at a proportion of not less than 70% by weight.

The coating line speed (that is, a speed at which a positive electrode mix containing a positive electrode active material is applied to a current collector; hereinafter referred to as “coating speed”) is within a range of 10 m/min to 200 m/min. The coating line speed during the coating operation can be adjusted by appropriately setting the device for applying a positive electrode active material.

<Negative Electrode Plate>

The negative electrode plate in accordance with an embodiment of the present invention is not limited to any particular one as long as the following requirement is met: In a case where the positive electrode plate and the negative electrode plate have each been processed into a disk having a diameter of 15.5 mm and immersed in a solution of ethylene carbonate, ethyl methyl carbonate, and diethyl carbonate which solution contains LiPF₆ at a concentration of 1 M, the sum of the interface barrier energies measured of the positive electrode plate and the negative electrode plate is not less than 5000 J/mol. The negative electrode plate is, for example, a sheet-shaped negative electrode plate including (i) as a negative electrode active material layer, a negative electrode mix containing a negative electrode active material and (ii) a negative electrode current collector supporting the negative electrode mix thereon. Note that the negative electrode plate may be such that the negative electrode current collector supports the negative electrode mix on both surfaces thereof or one of the surfaces thereof.

The sheet-shaped negative electrode plate preferably contains the above electrically conductive agent and binding agent.

Examples of the negative electrode active material include (i) a material capable of being doped with and dedoped of lithium ions, (ii) lithium metal, and (iii) lithium alloy. Examples of the material include carbonaceous materials. Examples of the carbonaceous materials include graphite such as natural graphite and artificial graphite.

Examples of the negative electrode current collector include Cu, Ni, and stainless steel. Among these, Cu is preferable as it is not easily alloyed with lithium in the case of a lithium-ion secondary battery in particular and is easily processed into a thin film.

Examples of a method for producing a sheet-shaped negative electrode plate include: a method in which a negative electrode active material is pressure-molded on a negative electrode current collector; and a method in which (i) a negative electrode active agent is formed into a paste with the use of a suitable organic solvent, (ii) a negative electrode current collector is coated with the paste, and then (iii) the paste is dried and then pressured so that the paste is firmly fixed to the negative electrode current collector. The above paste preferably includes the above electrically conductive agent and binding agent.

The negative electrode active material normally has an average particle diameter (D50) per volume of approximately 0.1 μm to 30 μm.

The negative electrode active material normally has an aspect ratio (that is, the long-axis diameter/the short-axis diameter) of approximately 1 to 10.

The negative electrode active material layer normally has a porosity of approximately 10% to 60%.

The negative electrode active material layer normally contains a negative electrode active material at a proportion of not less than 70% by weight, preferably not less than 80% by weight, more preferably not less than 90% by weight.

The coating line speed (that is, a speed at which a negative electrode mix containing a negative electrode active material is applied to a current collector; hereinafter referred to as “coating speed”) is within a range of 10 m/min to 200 m/min. The coating line speed during the coating operation can be adjusted by appropriately setting the device for applying a negative electrode active material.

The methods described under “(Positive electrode plate)” can be used to determine the particle diameter, aspect ratio, and porosity of the negative electrode active material, the proportion of the negative electrode active material in the negative electrode active material layer, and the coating speed.

<Sum of Interface Barrier Energies>

In a case where the positive electrode plate and the negative electrode plate in accordance with an embodiment of the present invention have each been (i) processed into a disk having a diameter of 15.5 mm and (ii) immersed in an EC/EMC/DEC solution (concentration: 1 M) of LiPF₆, the sum of the interface barrier energies measured of the positive electrode plate and the negative electrode plate is not less than 5000 J/mol. The sum of the interface barrier energies is preferably not less than 5100 J/mol, more preferably not less than 5200 J/mol.

The sum of the interface barrier energies being not less than 5000 J/mol allows ions and electric charge to move uniformly at the active material surface in the active material layer, and thereby allows the reactivity of the entire active material layer to be moderate and uniform. This should prevent (i) the internal structure of the active material layer from changing easily and (ii) the active material itself from degrading easily.

If the sum of the interface barrier energies is less than 5000 J/mol, the reactivity of the active material layer will be non-uniform, whereby the internal structure of the active material layer will be changed locally, and the active material will be degraded partially (for example, generation of gas).

For the above reason, the nonaqueous electrolyte secondary battery in accordance with an embodiment of the present invention, in which the sum of the interface barrier energies of the positive electrode plate and the negative electrode plate is not less than 5000 J/mol, advantageously maintains its good charge-discharge efficiency property after charge-discharge cycles.

The sum of the interface barrier energies has no particular upper limit. If the sum of the interface barrier energies is excessively high, however, that will undesirably prevent ions and electric charge from moving at the active material surface and thereby prevent the active material from being easily subjected to oxidation-reduction reaction resulting from charge and discharge. The sum of the interface barrier energies has an upper limit of, for example, approximately 15,000 J/mol.

The above-described sum of the interface barrier energies is determined by measuring the respective interface barrier energies of the positive electrode active material and the negative electrode active material and calculating the sum of the interface barrier energies through the procedure below.

(1) The positive electrode plate and the negative electrode plate are each cut into a disk having a diameter of 15 mm. The polyolefin porous film is also cut into a disk having a diameter of 17 mm for use as a separator.

(2) A mixed solvent is prepared that contains ethylene carbonate (EC), ethyl methyl carbonate (EMC), and diethyl carbonate (DEC) at a volume ratio of 3:5:2. LiPF₆ is dissolved in the mixed solvent at 1 mol/L for preparation of electrolyte.

(3) In a CR2032-type electrolytic bath, the negative electrode plate, the separator, the positive electrode plate, a stainless-steel plate (with a diameter of 15.5 mm and a thickness of 0.5 mm), and a waved washer are disposed on top of each other in this order from the bottom of the electrolytic bath. Then, the electrolyte is injected into the electrolytic bath, and the electrolytic bath is lidded, with the result of a coin cell being prepared.

(4) The coin cell prepared is placed in a thermostat bath. An alternating current impedance apparatus (FRA 1255B, available from Solartron) and CellTest System (1470E) are used at a frequency of 1 MHz to 0.1 Hz and a voltage amplitude of 10 mV to draw a Nyquist plot. The thermostat bath has a temperature of 50° C., 25° C., 5° C., or −10° C.

(5) The diameter of a half arc (or an arc of a flat circle) of the Nyquist plot drawn is used to determine the resistance r₁-r₂ of the positive electrode plate and the negative electrode plate at the electrode active material interface for different temperatures. The resistance r₁-r₂ is the sum of the resistance of the positive electrode and the negative electrode to ion movement and the resistance of the positive electrode and the negative electrode to electric charge movement. The half arc may be two completely separate arcs or a flat circle made of two overlapping circles. The sum of the interface barrier energies of the positive electrode active material and the negative electrode active material is calculated in accordance with Expressions (3) and (4) below.

k=1/(r₁+r₂)=Aexp(−Ea/RT) Expression (3)

ln(k)=ln{1/(r₁+r₂)}=ln(A)−Ea/RT Expression (4)

Ea: Sum of the respective interface barrier energies of the positive electrode active material and the negative electrode active material (J/mol)

k: Transfer constant

r₁-r₂: Resistance (Ω)

A: Frequency factor

R: Gas constant=8.314 J/mol/K

T: Temperature of the thermostat bath (K)

Expression (4) is an expression in which natural logarithms of both sides of Expression (3) are taken. In Expression (4), ln{1/(r₁+r₂)} is a linear function of 1/T. Thus, Ea/R is determined from the inclination of an approximate line obtained by plotting the results of substituting the resistance value at each temperature into Expression (4). Substituting the gas constant R into Ea/R allows the sum Ea of the respective interface barrier energies to be calculated.

The frequency factor A is a unique value that does not vary according to temperature changes. This value is determined depending on, for example, the molar concentration of lithium ions in the electrolyte bulk. According to Expression (4), the frequency factor A is the value of ln(1/r₀) for a case where (1/T)=0, and can be calculated on the basis of the above approximate line.

The sum of the interface barrier energies can be controlled on the basis of, for example, the ratio of the respective particle diameters of the positive electrode active material and the negative electrode active material. The ratio of the respective particle diameters of the positive electrode active material and the negative electrode active material, that is, (the particle diameter of the negative electrode active material/the particle diameter of the positive electrode active material), is preferably not more than 6.0. If (the particle diameter of the negative electrode active material/the particle diameter of the positive electrode active material) gives an excessively large value, the sum of the interface barrier energies tends to be excessively small.

<Nonaqueous Electrolyte>

A nonaqueous electrolyte in accordance with an embodiment of the present invention is a nonaqueous electrolyte generally used in a nonaqueous electrolyte secondary battery, and is not limited to any particular one. Examples of the nonaqueous electrolyte include a nonaqueous electrolyte prepared by dissolving a lithium salt in an organic solvent. Examples of the lithium salt include LiClO₄, LiPF₆, LiAsF₆, LiSbF6, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. The nonaqueous electrolyte can contain (i) only one kind of lithium salt or (ii) two or more kinds of lithium salts in combination.

Examples of the organic solvent to be contained in the nonaqueous electrolyte in accordance with an embodiment of the present invention include carbonates, ethers, nitriles, amides, carbamates, sulfur-containing compounds, and fluorine-containing organic solvents obtained by introducing a fluorine group into any of the above organic solvents. The nonaqueous electrolyte can contain (i) only one kind of organic solvent or (ii) two or more kinds of organic solvents in combination.

<Method for Producing Nonaqueous Electrolyte Secondary Battery>

A nonaqueous electrolyte secondary battery in accordance with an embodiment of the present invention can be produced by, for example, (i) forming a nonaqueous electrolyte secondary battery member in which the positive electrode plate, a nonaqueous electrolyte secondary battery laminated separator including the aforementioned porous film, and the negative electrode plate are arranged in this order, (ii) inserting the nonaqueous electrolyte secondary battery member into a container for use as a housing of the nonaqueous electrolyte secondary battery, (iii) filling the container with a nonaqueous electrolyte, and (iv) hermetically sealing the container under reduced pressure. A nonaqueous electrolyte secondary battery in accordance with an embodiment of the present invention may have any shape such as the shape of a thin plate (sheet), a disk, a cylinder, or a prism such as a cuboid. The method of producing the nonaqueous electrolyte secondary battery in accordance with an embodiment of the present invention is not limited to any particular one, and can be any conventionally publicly known method.

The nonaqueous electrolyte secondary battery in accordance with an embodiment of the present invention includes, as described above, (i) a nonaqueous electrolyte secondary battery separator including a polyolefin porous film, (ii) a porous layer, (iii) a positive electrode plate, and (iv) a negative electrode plate. The nonaqueous electrolyte secondary battery in accordance with an embodiment of the present invention meets the requirements (i) and (ii) below.

(i) The polyvinylidene fluoride-based resin contained in the porous layer contains an α-form polyvinylidene fluoride-based resin in an amount of not less than 35.0 mol % with respect to 100 mol % of the combined amount of the α-form polyvinylidene fluoride-based resin and a β-form polyvinylidene fluoride-based resin both contained in the polyvinylidene fluoride-based resin.

(ii) In a case where the positive electrode plate and the negative electrode plate have each been processed into a disk having a diameter of 15.5 mm and immersed in a solution of ethylene carbonate, ethyl methyl carbonate, and diethyl carbonate which solution contains LiPF₆ at a concentration of 1 M, the sum of the interface barrier energies measured of the positive electrode active material and the negative electrode active material is not less than 5000 J/mol.

The nonaqueous electrolyte secondary battery in accordance with an embodiment of the present invention preferably further meets the requirement (iii) below in addition to the requirements (i) and (ii).

(iii) The polyolefin porous film has a white index (WI) of not less than 85 and not more than 98, the white index (WI) being defined in American Standards Test Methods E313.

As a result of the requirement (i) being met, the nonaqueous electrolyte secondary battery in accordance with an embodiment of the present invention is such that the porous layer has a stable structure even after charge and discharge cycles. As a result of the requirement (iii) being met, the polyolefin porous film (separator) has an increased cation permeability. As a result of the requirement (ii) being met, the active material surface in the positive electrode active material layer and the negative electrode active material layer allows ions and electric charge to move uniformly during charge-discharge cycles, and the reactivity of the entire active material layer is moderate and uniform. This prevents (i) the internal structure of the active material layer from changing easily and (ii) the active material itself from degrading easily.

A nonaqueous electrolyte secondary battery that meets the requirements (i) and (ii) is thus configured such that (a) the porous layer has a stable structure even after charge and discharge cycles and that (b) the reactivity of the active material in the active material layer is uniform, thereby preventing the active material layer from degrading easily. This should allow the nonaqueous electrolyte secondary battery in accordance with an embodiment of the present invention to maintain its charge-discharge efficiency property after charge-discharge cycles. For instance, the nonaqueous electrolyte secondary battery in accordance with an embodiment of the present invention maintains its charge-discharge efficiency for a 1 C charge and a high discharge rate of 20 C even after 100 charge-discharge cycles. More specifically, the nonaqueous electrolyte secondary battery in accordance with an embodiment of the present invention has a charge-discharge efficiency of not less than 90% for a 1 C charge and a high discharge rate of 20 C after 100 charge-discharge cycles.

Further, as a result of the requirement (iii) being met, the nonaqueous electrolyte secondary battery not only has the benefits (a) and (b), but also is configured such that the polyolefin porous film has an increased cation permeability. This allows the nonaqueous electrolyte secondary battery in accordance with an embodiment of the present invention to more effectively maintain its charge-discharge efficiency property after charge-discharge cycles.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss embodiments of the present invention in greater detail with reference to Examples and Comparative Examples. Note, however, that the present invention is not limited to the following Examples.

[Measurement Methods]

In the Examples and Comparative Examples, measurements were made by the methods below.

(1) Film Thickness (Unit: μm)

The respective thicknesses of a porous film, a positive electrode active material layer, and a negative electrode active material layer were measured with use of a high-accuracy digital length measuring machine (VL-50) available from Mitutoyo Corporation. The thickness of a positive electrode active material layer was calculated by subtracting the thickness of an aluminum foil as a current collector from the thickness of the positive electrode plate. The thickness of a negative electrode active material layer was calculated by subtracting the thickness of a copper foil as a current collector from the thickness of the negative electrode plate.

(2) White Index (WI)

The WI value of a porous film was measured by Specular Component Included (SCI) method (including specular reflection) with use of a spectrocolorimeter (CM-2002, available from MINOLTA) on black paper (available from Hokuetsu Kishu Paper Co., Ltd., colored high-quality paper, black, thickest type, shirokuhan (788 mm×1091 mm with the long side extending in a machine direction)).

(3) Method for Calculating a Rate

A piece with a size of approximately 2 cm×5 cm was cut out from each of the laminated separators produced in the Examples and Comparative Examples below. Then, the rate of content (a rate) of an α-form PVDF-based resin in the PVDF-based resin contained in the cutout was measured through the above steps (1) to (4) (that is, by the method for calculating the respective rates of content of the α-form PVDF-based resin and the β-form PVDF-based resin in a PVDF-based resin).

(4) Respective Average Particle Diameters of Positive Electrode Active Material and Negative Electrode Active Material

The volume-based particle size distribution and average particle diameter (D50) were measured with use of a laser diffraction particle size analyzer (product name: SALD2200, available from Shimadzu Corporation).

(5) Measurement of Porosity of Positive Electrode Active Material Layer

The porosity of the positive electrode active material layer included in a positive electrode plate in Example 1 below was measured by the method below. The porosity of the positive electrode active material layer included in a positive electrode plate in any other Example below was measured by a similar method.

A positive electrode plate prepared by applying a layer of a positive electrode mix (a mixture of LiNi_{0.5}Mn_{0.3}Co_{0.2}O₂, an electrically conductive agent, and PVDF (at a weight ratio of 92:5:3)) on one surface of a positive electrode current collector (aluminum foil) was cut into a piece having a size of 14.5 cm² (4.5 cm×3 cm+1 cm×1 cm). The cut piece of the positive electrode plate had a mass of 0.215 g and had a thickness of 58 μm. The positive electrode current collector was cut into a piece having the same size as the cut piece of the positive electrode plate. The cut piece of the positive electrode current collector had a mass of 0.078 g and had a thickness of 20 μm.

The density p of the positive electrode active material layer was calculated as (0.215−0.078)/{(58−20)/10000×14.5}=2.5 g/cm³.

Each of the materials contained in the positive electrode mix had a real density as follows: LiNi_{0.5}Mn_{0.3}Co_{0.2}O₂, an electrically conductive agent, and PVDF had real densities of 4.68 g/cm³, 1.8 g/cm³, and 1.8 g/cm³, respectively.

The positive electrode active material layer had a porosity ε of 40%, which was determined by calculation from the above values by the following formula:

ε=[1−{2.5×(92/100)/4.68+2.5×(5/100)/1.8+2.5×(3/100)/1.8}]*100=40% (Formula)

(6) Measurement of Porosity of Negative Electrode Active Material Layer

The porosity of the negative electrode active material layer included in a negative electrode plate in Example 1 below was measured by the method below. The porosity of the negative electrode active material layer included in a negative electrode plate in any other Example below was measured by a similar method.

A negative electrode plate prepared by applying a layer of a negative electrode mix (a mixture of graphite, styrene-1,3-butadiene copolymer, and sodium carboxymethyl cellulose (at a weight ratio of 98:1:1)) on one surface of a negative electrode current collector (copper foil) was cut into a piece having a size of 18.5 cm² (5 cm×3.5 cm+1 cm×1 cm). The cut piece of the negative electrode plate had a mass of 0.266 g and had a thickness of 48 μm. The negative electrode current collector was cut into a piece having the same size as the cut piece of the negative electrode plate. The cut piece of the negative electrode current collector had a mass of 0.162 g and had a thickness of 10 μm.

The density p of the negative electrode active material layer was calculated as (0.266−0.162)/{(48−10)/10000×18.5}=1.49 g/cm³.

Each of the materials contained in the negative electrode mix had a real density as follows: graphite, styrene-1,3-butadiene copolymer, and sodium carboxymethyl cellulose had real densities of 2.2 g/cm³, 1 g/cm³, and 1.6 g/cm³, respectively.

The negative electrode active material layer had a porosity ε of 31%, which was determined by calculation from the above values by the following formula:

ε=[1−{1.49×(98/100)/2.2+1.49×(1/100)/1+1.49×(1/100)/1.6}]*100=31% (Formula)

(7) Sum of the Respective Interface Barrier Energies of the Positive Electrode Active Material and the Negative Electrode Active Material

The sum of the interface barrier energies was calculated through the steps (1) to (5) described in the “<Sum of interface barrier energies>” section.

(8) Charge-Discharge Efficiency Property for a 1 C Charge and a High Discharge Rate (20 C) After 100 Charge-Discharge Cycles

a. Initial Charge and Discharge

Nonaqueous electrolyte secondary batteries each of which was produced in one of the Examples and Comparative Examples and each of which had not been subjected to any charge-discharge cycle were each subjected to four cycles of initial charge and discharge at 25° C. Each of the four cycles of initial charge and discharge was carried out (i) at a voltage ranging from 2.7 V to 4.1 V, (ii) with CC-CV charge at a charge current value of 0.2 C (where the terminal current condition was 0.02 C), and (iii) with CC discharge at a discharge current value of 0.2 C (where the value of an electric current at which a battery rated capacity defined as a one-hour rate discharge capacity was discharged in one hour was assumed to be 1 C; the same applies hereinafter). Note here that the “CC-CV charge” is a charging method in which (i) a battery is charged at a constant electric current set, (ii) after a certain voltage is reached, the certain voltage is maintained while the electric current is being reduced. Note also that the “CC discharge” is a discharging method in which a battery is discharged at a constant electric current until a certain voltage is reached (the same applies hereinafter).

b. Cycle Test

The nonaqueous electrolyte secondary batteries, which had been subjected to initial charge and discharge, were each subjected to 100 charge-discharge cycles at 55° C. Each of the 100 charge-discharge cycles was carried out (i) at a voltage ranging from 2.7 V to 4.2 V, (ii) with CC-CV charge at a charge current value of 1 C (where the terminal current condition was 0.02 C), and (iii) with CC discharge at a discharge current value of 10 C.

c. Test of Charge-Discharge Efficiency for High-Rate Measurement After 100 Cycles

The nonaqueous electrolyte secondary batteries, which had been subjected to 100 charge-discharge cycles, were each subjected to charge-discharge cycles. Each of the charge-discharge cycles was carried out (i) at a voltage ranging from 2.7 V to 4.2 V, (ii) with CC-CV charge at a charge current value of 1 C (where the terminal current condition was 0.02 C), and (iii) with CC discharge at a discharge current value changed in the order of 0.2 C, 1 C, 5 C, 10 C, and 20 C. The nonaqueous electrolyte secondary batteries were subjected to three such charge-discharge cycles at 55° C. for each rate.

Next, in a test with a discharge current of 20 C, the discharge capacity for 20 C was divided by the charge capacity for 1 C, and the quotient was used as the charge-discharge efficiency for high-rate measurement after 100 cycles. The division was based on the values at the third cycle of 1 C charge and 20 C discharge.

### Example 1

[Production of Nonaqueous Electrolyte Secondary Battery Laminated Separator]

Ultra-high molecular weight polyethylene powder (GUR2024, available from Ticona Corporation) having a weight-average molecular weight of 4,970,000 and polyethylene wax (FNP-0115, available from Nippon Seiro Co., Ltd.) having a weight-average molecular weight of 1,000 were mixed for preparation of a mixture containing the ultra-high molecular weight polyethylene powder at a proportion of 68.0% by weight and the polyethylene wax at a proportion of 32.0% by weight. Assuming that the ultra-high molecular weight polyethylene powder and the polyethylene wax of the mixture had 100 parts by weight in total, to the 100 parts by weight of the mixture, 0.4 parts by weight of an antioxidant (Irg1010, available from Ciba Specialty Chemicals Corporation), 0.1 parts by weight of an antioxidant (P168, available from Ciba Specialty Chemicals Corporation), and 1.3 parts by weight of sodium stearate were added, and then calcium carbonate having a BET specific surface area of 11.8 m²/g (available from Maruo Calcium Co., Ltd.) was further added so as to account for 38% by volume of the entire volume of the resultant mixture. Then, the resultant mixture was mixed as it was, that is, in the form of powder, in a Henschel mixer, and thereafter the mixture was melted and kneaded with use of a twin screw kneading extruder. This produced a polyolefin resin composition.

Next, the polyolefin resin composition was rolled with use of a pair of rollers each having a surface temperature of 150° C. This produced a sheet of the polyolefin resin composition. This sheet was immersed in an aqueous hydrochloric acid solution (containing 4 mol/L of hydrochloric acid and 1.0% by weight of nonionic surfactant) having a temperature of 43° C. for removal of the calcium carbonate, and was then cleaned with water at 45° C. Subsequently, the sheet thus cleaned was stretched 6.2-fold at 100° C. with use of a tenter uniaxial stretching machine available from Ichikin Co., Ltd. This produced a porous film 1. The porous film 1 produced had a film thickness of 10.0 μm, a weight per unit area of 6.4 g/m², and a white index (WI) of 87.

An N-methyl-2-pyrrolidone (hereinafter referred to also as “NMP”) solution (available from Kureha Corporation; product name: L #9305, weight-average molecular weight: 1,000,000) containing a PVDF-based resin (polyvinylidene fluoride-hexafluoropropylene copolymer) was prepared as a coating solution. The coating solution was applied by a doctor blade method to the porous film 1 so that the applied coating solution weighed 6.0 g per square meter of the PVDF-based resin in the coating solution.

The porous film, to which the coating solution had been applied, was immersed into 2-propanol while the coating film was wet with the solvent, and was then left to stand still at −10° C. for 5 minutes. This produced a laminated porous film 1. The laminated porous film 1 produced was further immersed into other 2-propanol while the laminated porous film 1 was wet with the above immersion solvent, and was then left to stand still at 25° C. for 5 minutes. This produced a laminated porous film la. The laminated porous film la produced was dried at 130° C. for 5 minutes. This produced a laminated separator 1 including a porous layer. Table 1 shows the results of evaluation of the laminated separator 1 produced.

[Preparation of Nonaqueous Electrolyte Secondary Battery]

(Positive Electrode Plate)

A positive electrode plate was obtained in which a layer of a positive electrode mix (a mixture of LiNi_{0.5}Mn_{0.3}Coo.202 having an average particle diameter (D50) of 5 μm based on a volume, an electrically conductive agent, and PVDF (at a weight ratio of 92:5:3)) was applied on one surface of a positive electrode current collector (aluminum foil). In the positive electrode plate thus obtained, a positive electrode active material layer had a porosity of 40%.

The positive electrode plate was partially cut off so that a positive electrode active material layer was present in an area of 45 mm×30 mm and that this area was surrounded by an area with a width of 13 mm in which area no positive electrode active material layer was present. A portion thus cut was used as a positive electrode plate 1.

(Negative Electrode Plate)

A negative electrode plate was obtained in which a layer of a negative electrode mix (a mixture of natural graphite having an average particle diameter (D50) of 15 μm based on a volume, styrene-1,3-butadiene copolymer, and sodium carboxymethyl cellulose (at a weight ratio of 98:1:1)) was applied on one surface of a negative electrode current collector (copper foil). In the negative electrode plate thus obtained, a negative electrode active material layer had a porosity of 31%.

The negative electrode plate was partially cut off so that a negative electrode active material layer was present in an area of 50 mm×35 mm and that this area was surrounded by an area with a width of 13 mm in which area no negative electrode active material layer was present. A portion thus cut was used as a negative electrode plate 1. The ratio of the respective particle diameters of the active material of the positive electrode plate 1 and the active material of the negative electrode plate 1 (the particle diameter of the negative electrode active material/the particle diameter of the positive electrode active material) was 3.0. Table 1 shows the results of evaluation of the sum of the interface barrier energies measured of the positive electrode plate 1 and the negative electrode plate 1.

(Assembly of Nonaqueous Electrolyte Secondary Battery)

A nonaqueous electrolyte secondary battery was produced with use of the positive electrode plate 1, the negative electrode plate 1, and the laminated separator 1 by the method below.

In a laminate pouch, the positive electrode plate 1, the laminated separator 1 with the porous layer facing the positive electrode, and the negative electrode plate 1 were disposed (arranged) on top of one another so as to obtain a nonaqueous electrolyte secondary battery member 1. During this operation, the positive electrode plate 1 and the negative electrode plate 1 were arranged so that the positive electrode active material layer of the positive electrode plate 1 had a main surface that was entirely covered by the main surface of the negative electrode active material layer of the negative electrode plate 1.

Subsequently, the nonaqueous electrolyte secondary battery member 1 was put into a bag prepared in advance from a laminate of an aluminum layer and a heat seal layer. Further, 0.23 mL of nonaqueous electrolyte was put into the bag. The above nonaqueous electrolyte was prepared by dissolving LiPF₆ in a mixed solvent of ethylene carbonate, ethyl methyl carbonate, and diethyl carbonate at a ratio of 3:5:2 (volume ratio) so that the LiPF₆ would be contained at 1 mol/L. The bag was then heat-sealed while the pressure inside the bag was reduced. This produced a nonaqueous electrolyte secondary battery 1.

Table 1 shows the results of evaluation of the nonaqueous electrolyte secondary battery 1 produced.

### Example 2

[Production of Nonaqueous Electrolyte Secondary Battery Laminated Separator]

Ultra-high molecular weight polyethylene powder

(GUR4032, available from Ticona Corporation) having a weight-average molecular weight of 4,970,000 and polyethylene wax (FNP-0115, available from Nippon Seiro Co., Ltd.) having a weight-average molecular weight of 1,000 were mixed for preparation of a mixture containing the ultra-high molecular weight polyethylene powder at a proportion of 70.0% by weight and the polyethylene wax at a proportion of 30.0% by weight. Assuming that the ultra-high molecular weight polyethylene powder and the polyethylene wax of the mixture had 100 parts by weight in total, to the 100 parts by weight of the mixture, 0.4 parts by weight of an antioxidant (Irg1010, available from Ciba Specialty Chemicals Corporation), 0.1 parts by weight of an antioxidant (P168, available from Ciba Specialty Chemicals Corporation), and 1.3 parts by weight of sodium stearate were added, and then calcium carbonate having a BET specific surface area of 11.6 m²/g (available from Maruo Calcium Co., Ltd.) was further added so as to account for 36% by volume of the entire volume of the resultant mixture. Then, the resultant mixture was mixed as it was, that is, in the form of powder, in a Henschel mixer, and thereafter the mixture was melted and kneaded with use of a twin screw kneading extruder. This produced a polyolefin resin composition.

Next, the polyolefin resin composition was rolled with use of a pair of rollers each having a surface temperature of 150° C. This produced a sheet of the polyolefin resin composition. This sheet was immersed in an aqueous hydrochloric acid solution (containing 4 mol/L of hydrochloric acid and 6.0% by weight of nonionic surfactant) having a temperature of 38° C. for removal of the calcium carbonate, and was then cleaned with water at 40° C. Subsequently, the sheet thus cleaned was stretched 6.2-fold at 105° C. with use of a tenter uniaxial stretching machine available from Ichikin Co., Ltd. This produced a porous film 2. The porous film 2 produced had a film thickness of 15.6 μm, a weight per unit area of 5.4 g/m², and a white index (WI) of 97.

A coating solution was applied to the porous film 2 as in Example 1. The porous film, to which the coating solution had been applied, was immersed into 2-propanol while the coating film was wet with the solvent, and was then left to stand still at 25° C. for 5 minutes. This produced a laminated porous film 2. The laminated porous film 2 produced was further immersed into other 2-propanol while the laminated porous film 2 was wet with the above immersion solvent, and was then left to stand still at 25° C. for 5 minutes. This produced a laminated porous film 2a. The laminated porous film 2a produced was dried at 65° C. for 5 minutes. This produced a laminated separator 2 including a porous layer. Table 1 shows the results of evaluation of the laminated separator 2 produced.

[Preparation of Nonaqueous Electrolyte Secondary Battery]

A nonaqueous electrolyte secondary battery was prepared by a method similar to the method for Example 1 except that the laminated separator 1 was replaced with the laminated separator 2. The nonaqueous electrolyte secondary battery thus prepared was used as a nonaqueous electrolyte secondary battery 2.

Table 1 shows the results of evaluation of the nonaqueous electrolyte secondary battery 2 produced.

### Example 3

[Production of Nonaqueous Electrolyte Secondary Battery Laminated Separator]

Ultra-high molecular weight polyethylene powder (GUR4032, available from Ticona Corporation) having a weight-average molecular weight of 4,970,000 and polyethylene wax (FNP-0115, available from Nippon Seiro Co., Ltd.) having a weight-average molecular weight of 1,000 were mixed for preparation of a mixture containing the ultra-high molecular weight polyethylene powder at a proportion of 71.5% by weight and the polyethylene wax at a proportion of 28.5% by weight. Assuming that the ultra-high molecular weight polyethylene powder and the polyethylene wax of the mixture had 100 parts by weight in total, to the 100 parts by weight of the mixture, 0.4 parts by weight of an antioxidant (Irg1010, available from Ciba Specialty Chemicals Corporation), 0.1 parts by weight of an antioxidant (P168, available from Ciba Specialty Chemicals Corporation), and 1.3 parts by weight of sodium stearate were added, and then calcium carbonate having a BET specific surface area of 11.8 m²/g (available from Maruo Calcium Co., Ltd.) was further added so as to account for 37% by volume of the entire volume of the resultant mixture. Then, the resultant mixture was mixed as it was, that is, in the form of powder, in a Henschel mixer, and thereafter the mixture was melted and kneaded with use of a twin screw kneading extruder. This produced a polyolefin resin composition.

Next, the polyolefin resin composition was rolled with use of a pair of rollers each having a surface temperature of 150° C. This produced a sheet of the polyolefin resin composition. This sheet was immersed in an aqueous hydrochloric acid solution (containing 4 mol/L of hydrochloric acid and 1.0% by weight of nonionic surfactant) having a temperature of 43° C. for removal of the calcium carbonate, and was then cleaned with water at 45° C. Subsequently, the sheet thus cleaned was stretched 7.0-fold at 100° C. with use of a tenter uniaxial stretching machine available from Ichikin Co., Ltd. This produced a porous film 3. The porous film 3 produced had a film thickness of 10.3 μm, a weight per unit area of 5.2 g/m², and a white index (WI) of 91.

A coating solution was applied to the porous film 3 as in Example 1. The porous film, to which the coating solution had been applied, was immersed into 2-propanol while the coating film was wet with the solvent, and was then left to stand still at −5° C. for 5 minutes. This produced a laminated porous film 3. The laminated porous film 3 produced was further immersed into other 2-propanol while the laminated porous film 3 was wet with the above immersion solvent, and was then left to stand still at 25° C. for 5 minutes. This produced a laminated porous film 3a. The laminated porous film 3a produced was dried at 30° C. for 5 minutes. This produced a laminated separator 3 including a porous layer. Table 1 shows the results of evaluation of the laminated separator 3 produced.

[Preparation of Nonaqueous Electrolyte Secondary Battery]

A nonaqueous electrolyte secondary battery was prepared by a method similar to the method for Example 1 except that the laminated separator 1 was replaced with the laminated separator 3. The nonaqueous electrolyte secondary battery thus prepared was used as a nonaqueous electrolyte secondary battery 3.

Table 1 shows the results of evaluation of the nonaqueous electrolyte secondary battery 3 produced.

### Example 4

(Positive Electrode Plate)

A positive electrode plate was obtained in which a layer of a positive electrode mix (a mixture of LiCoO₂ having an average particle diameter (D50) of 13 μm based on a volume, an electrically conductive agent, and PVDF (at a weight ratio of 100:5:3)) was applied on one surface of a positive electrode current collector (aluminum foil). In the positive electrode plate thus obtained, a positive electrode active material layer had a porosity of 31%.

The positive electrode plate was partially cut off so that a positive electrode active material layer was present in an area of 45 mm×30 mm and that this area was surrounded by an area with a width of 13 mm in which area no positive electrode active material layer was present. A portion thus cut was used as a positive electrode plate 2. The ratio of the respective particle diameters of the active material of the positive electrode plate 2 and the active material of the negative electrode plate 1 (the particle diameter of the negative electrode active material/the particle diameter of the positive electrode active material) was 1.1. Table 1 shows the results of evaluation of the sum of the interface barrier energies measured of the positive electrode plate 2 and the negative electrode plate 1.

[Preparation of Nonaqueous Electrolyte Secondary Battery]

A nonaqueous electrolyte secondary battery was prepared by a method similar to the method for Example 1 except that the laminated separator 1 was replaced with the laminated separator 3 and that the positive electrode plate 2 was used as a positive electrode plate. The nonaqueous electrolyte secondary battery thus prepared was used as a nonaqueous electrolyte secondary battery 4.

Table 1 shows the results of evaluation of the nonaqueous electrolyte secondary battery 4 produced.

### Example 5

(Negative Electrode Plate)

A negative electrode plate was obtained in which a layer of a negative electrode mix (a mixture of artificial graphite having an average particle diameter (D50) of 20 μm based on a volume, styrene-1,3-butadiene copolymer, and sodium carboxymethyl cellulose (at a weight ratio of 98:1:1)) was applied on one surface of a negative electrode current collector (copper foil). In the negative electrode plate thus obtained, a negative electrode active material layer had a porosity of 35%.

The negative electrode plate was partially cut off so that a negative electrode active material layer was present in an area of 50 mm×35 mm and that this area was surrounded by an area with a width of 13 mm in which area no negative electrode active material layer was present. A portion thus cut was used as a negative electrode plate 2. The ratio of the respective particle diameters of the active material of the positive electrode plate 2 and the active material of the negative electrode plate 2 (the particle diameter of the negative electrode active material/the particle diameter of the positive electrode active material) was 1.5. Table 1 shows the results of evaluation of the sum of the interface barrier energies measured of the positive electrode plate 2 and the negative electrode plate 2.

[Preparation of Nonaqueous Electrolyte Secondary Battery]

The positive electrode plate 2 was used as a positive electrode plate, and the negative electrode plate 2 was used as a negative electrode plate. A nonaqueous electrolyte secondary battery was prepared by a method similar to the method for Example 1 except that the laminated separator 1 was replaced with the laminated separator 3. The nonaqueous electrolyte secondary battery thus prepared was used as a nonaqueous electrolyte secondary battery 5.

Table 1 shows the results of evaluation of the nonaqueous electrolyte secondary battery 5 produced.

### Example 6

[Preparation of Insulating Porous Layer and Laminated Separator]

In N-methyl-2-pyrrolidone, a PVDF-based resin (product name: “Kynar (registered trademark) LBG”, available from Arkema Inc.; weight-average molecular weight of 590,000) was stirred and dissolved at 65° C. for 30 minutes so that the solid content was 10% by mass. The resulting solution was used as a binder solution. As a filler, fine alumina particles (product name: “AKP3000”, available from Sumitomo Chemical Co., Ltd.; containing 5 ppm of silicon) was used. The fine alumina particles, the binder solution, and a solvent (N-methyl-2-pyrrolidone) were mixed together at the following ratio: The fine alumina particles, the binder solution, and the solvent were mixed together so that (i) the resulting mixed solution contained 10 parts by weight of the PVDF-based resin with respect to 90 parts by weight of the fine alumina particles and (ii) the solid content concentration (fine alumina particles+PVDF-based resin) of the mixed solution was 10% by weight. A dispersion solution was thus obtained. The coating solution was applied by a doctor blade method to the porous film 3 produced in Example 3 so that the applied coating solution weighed 6.0 g per square meter of the PVDF-based resin in the coating solution. This produced a laminated porous film 4. The laminated porous film 4 was dried at 65° C. for 5 minutes. This produced a laminated separator 4. The drying operation involved hot air blown in an air direction perpendicular to the porous film 3 at an air velocity of 0.5 m/s. Table 1 shows the results of evaluation of the laminated separator 4 produced.

[Preparation of Nonaqueous Electrolyte Secondary Battery]

A nonaqueous electrolyte secondary battery was prepared by a method similar to the method for Example 1 except that the laminated separator 1 was replaced with the laminated separator 4. The nonaqueous electrolyte secondary battery thus prepared was used as a nonaqueous electrolyte secondary battery 6.

Table 1 shows the results of evaluation of the nonaqueous electrolyte secondary battery 6 produced.

### Comparative Example 1

[Preparation of Nonaqueous Electrolyte Secondary Battery]

[Production of Nonaqueous Electrolyte Secondary Battery Separator]

A porous film to which a coating solution had been applied as in Example 3 was immersed into 2-propanol while the coating film was wet with the solvent, and was then left to stand still at −78° C. for 5 minutes. This produced a laminated porous film 5. The laminated porous film 5 produced was further immersed into other 2-propanol while the laminated porous film 5 was wet with the above immersion solvent, and was then left to stand still at 25° C. for 5 minutes. This produced a laminated porous film 5a. The laminated porous film 5a produced was dried at 30° C. for 5 minutes. This produced a laminated separator 5 including a porous layer. Table 1 shows the results of evaluation of the laminated separator 5 produced.

[Preparation of Nonaqueous Electrolyte Secondary Battery]

A nonaqueous electrolyte secondary battery was prepared by a method similar to the method for Example 1 except that the laminated separator 1 was replaced with the laminated separator 5. The nonaqueous electrolyte secondary battery thus prepared was used as a nonaqueous electrolyte secondary battery 8.

Table 1 shows the results of evaluation of the nonaqueous electrolyte secondary battery 7 produced.

### Comparative Example 2

(Negative Electrode Plate)

A negative electrode plate was obtained in which a layer of a negative electrode mix (a mixture of artificial spherocrystal graphite having an average particle diameter (D50) of 34 μm based on a volume, an electrically conductive agent, and PVDF (at a weight ratio of 85:15:7.5)) was applied on one surface of a negative electrode current collector (copper foil). In the negative electrode plate thus obtained, a negative electrode active material layer had a porosity of 34%.

The negative electrode plate was partially cut off so that a negative electrode active material layer was present in an area of 50 mm×35 mm and that this area was surrounded by an area with a width of 13 mm in which area no negative electrode active material layer was present. A portion thus cut was used as a negative electrode plate 3. Table 1 shows the results of evaluation of the sum of the interface barrier energies measured of the positive electrode plate 1 and the negative electrode plate 3.

[Preparation of Nonaqueous Electrolyte Secondary Battery]

The negative electrode plate 3 was used as a negative electrode plate. A nonaqueous electrolyte secondary battery was prepared by a method similar to the method for Example 1 except that the laminated separator 1 was replaced with the laminated separator 3. The ratio of the respective particle diameters of the active material of the positive electrode plate 1 and the active material of the negative electrode plate 3 (the particle diameter of the negative electrode active material/the particle diameter of the positive electrode active material) was 6.8. The nonaqueous electrolyte secondary battery thus prepared was used as a nonaqueous electrolyte secondary battery 8.

Table 1 shows the results of evaluation of the nonaqueous electrolyte secondary battery 8 produced.

TABLE 1

| | Porous | | Nonaqueous electrolyte |
|---|---|---|---|
| | layer | Electrode | secondary battery |
| | PVDF α | Sum of interface | Charge-discharge efficiency |
| | rate | barrier energies | at 1 C charge/20 C |
| | (mol %) | (J/mol) | discharge after 100 cycles |
| Example 1 | 59.6 | 9069 | 99.5% |
| Example 2 | 80.8 | 9069 | 96.5% |
| Example 3 | 44.4 | 9069 | 97.5% |
| Example 4 | 44.4 | 12612 | 98.4% |
| Example 5 | 44.4 | 15173 | 93.7% |
| Example 6 | 64.3 | 9069 | 98.3% |
| Comparative | 34.6 | 9069 | 89.8% |
| Example 1 | | | |
| Comparative | 44.4 | 4883 | 89.4% |
| Example 2 | | | |

### CONCLUSION

Table 1 shows that the nonaqueous electrolyte secondary batteries produced in Examples 1 to 6 were superior to the nonaqueous electrolyte secondary batteries produced in Comparative Examples 1 and 2 in terms of the charge-discharge efficiency property for a 1 C charge and a 20 C discharge after 100 cycles. The nonaqueous electrolyte secondary batteries produced in Examples 1 to 6 each had a charge-discharge efficiency of not less than 90% for a 1 C charge and a 20 C discharge after 100 charge-discharge cycles.

Table 1 therefore proves that a nonaqueous electrolyte secondary battery that meets requirement (i) of the polyvinylidene fluoride-based resin contained in the porous layer containing an α-form polyvinylidene fluoride-based resin in an amount of not less than 35.0 mol % with respect to 100 mol % of the combined amount of the α-form polyvinylidene fluoride-based resin and a β-form polyvinylidene fluoride-based resin contained in the polyvinylidene fluoride-based resin and requirement (ii) of the sum of the interface barrier energies of the positive electrode active material and the negative electrode active material being not less than 5000 J/mol maintains its charge-discharge efficiency property after charge-discharge cycles.

### Referential Example

### Controlling the Interface Barrier Energies

A positive electrode plate and a negative electrode plate were prepared for which the ratio of the respective particle diameters of a positive electrode active material and a negative electrode active material had been adjusted. The sum of the interface barrier energies was measured. Specifically, a positive electrode plate and a negative electrode plate were prepared that contained respective active materials each having a particle diameter changed as below while the composition was identical to that for Example 1. Table 2 shows the results of measurement of the respective interface barrier energies of the positive electrode plate and the negative electrode plate.

Further, a nonaqueous electrolyte secondary battery was prepared as in Example 1 except that the above positive electrode plate and negative electrode plate were used. The charge-discharge efficiency for a 1 C charge and a 20 C discharge of the nonaqueous electrolyte secondary battery after 100 charge-discharge cycles was measured. Table 2 shows the results.

TABLE 2

| | | | | Sum of | Charge-discharge |
|---|---|---|---|---|---|
| | Average particle | Average particle | | interface | efficiency at |
| | diameter of positive | diameter of negative | Ratio of | barrier | 1 C charge/20 C |
| | electrode active | electrode active | particle | energies | discharge after |
| | material (μm) | material (μm) | diameters | (J/mol) | 100 cycles |
| Example 1 | 5 | 15 | 3 | 9069 | 99.5% |
| Referential | 0.8 | 20.3 | 24.7 | 4228 | 85.6% |
| Example | | | | | |

[Results]

The positive electrode plate and the negative electrode plate for Example 1 were identical in composition to the positive electrode plate and the negative electrode plate for the Referential Example. The ratio of the respective particle diameters of the positive electrode active material and the negative electrode active material, that is, (the particle diameter of the negative electrode active material/the particle diameter of the positive electrode active material), was 3 for Example 1, but was 24.7 for the Referential Example. The sum of the interface barrier energies was 9069 J/mol for Example 1, but was only 4228 J/mol for the Referential Example.

These experimental results show that the sum of the interface barrier energies can be effectively controlled by, for example, adjusting the ratio of the respective particle diameters of the positive electrode active material and the negative electrode active material. It is needless to say that the sum of the interface barrier energies may be controlled by another method.

The charge-discharge efficiency for a 1 C charge and a 20 C discharge after 100 charge-discharge cycles was 99.5% for Example 1, but was only 85.6% for the Referential Example. These experimental results more clearly show that controlling the sum of the interface barrier energies so that it is a predetermined value is one factor in maintaining a good charge-discharge efficiency property of a battery after charge-discharge cycles.

### INDUSTRIAL APPLICABILITY

A nonaqueous electrolyte secondary battery in accordance with an embodiment of the present invention maintains its charge-discharge efficiency property after charge-discharge cycles. The nonaqueous electrolyte secondary battery in accordance with an embodiment of the present invention is thus suitable for use as (i) a battery for use in devices such as a personal computer, a mobile telephone, and a portable information terminal and (ii) an on-vehicle battery.

1. A nonaqueous electrolyte secondary battery, comprising:
a nonaqueous electrolyte secondary battery separator including a polyolefin porous film;
a porous layer containing a polyvinylidene fluoride-based resin;
a positive electrode plate; and
a negative electrode plate,
in a case where the positive electrode plate and the negative electrode plate have each been processed into a disk having a diameter of 15.5 mm and immersed in a solution of ethylene carbonate, ethyl methyl carbonate, and diethyl carbonate which solution contains LiPF₆ at a concentration of 1 M, a sum of respective interface barrier energies measured of a positive electrode active material and a negative electrode active material being not less than 5000 J/mol,
the porous layer being between (i) the nonaqueous electrolyte secondary battery separator and (ii) at least one of the positive electrode plate and the negative electrode plate,
the polyvinylidene fluoride-based resin containing an α-form polyvinylidene fluoride-based resin in an amount of not less than 35.0 mol % with respect to 100 mol % of a combined amount of the α-form polyvinylidene fluoride-based resin and a β-form polyvinylidene fluoride-based resin both contained in the polyvinylidene fluoride-based resin,
the amount of the α-form polyvinylidene fluoride-based resin being calculated by (i) waveform separation of (α/2) observed at around −78 ppm in a ¹⁹F-NMR spectrum obtained from the porous layer and (ii) waveform separation of {(α/2)+β} observed at around −95 ppm in the ¹⁹F-NMR spectrum.

2. The nonaqueous electrolyte secondary battery according to claim 1,
wherein the positive electrode plate contains a transition metal oxide.

3. The nonaqueous electrolyte secondary battery according to claim 1,
wherein the negative electrode plate contains a graphite.

4. The nonaqueous electrolyte secondary battery according to claim 1, further comprising:
another porous layer which is provided between (i) the nonaqueous electrolyte secondary battery separator and (ii) at least one of the positive electrode plate and the negative electrode plate.

5. The nonaqueous electrolyte secondary battery according to claim 4, wherein
the another porous layer contains at least one resin selected from the group consisting of a polyolefin, a (meth)acrylate-based resin, a fluorine-containing resin (excluding a polyvinylidene fluoride-based resin), a polyamide-based resin, a polyester-based resin, and a water-soluble polymer.

6. The nonaqueous electrolyte secondary battery according to claim 5, wherein
the polyamide-based resin is aramid resin.
